(19) United States
(12) Patent Application Publication
(10) Pub. No.: US 2021/0226859 A1
(43) Pub. Date: Jul. 22, 2021

(54) Determination of Model Based Charge Back in Cloud Application

(71) Applicant: Prashant Shyamsundar Mishra, Redmond, WA (US)

(72) Inventor: Prashant Shyamsundar Mishra, Redmond, WA (US)

(21) Appl. No.: 16/747,540

(22) Filed: Jan. 21, 2020

(51) Int. Cl. H04L 12/24; H04L 29/08; H04L 12/26

(52) U.S. Cl. CPC H04L 41/5029; H04L 67/1012; H04L 67/16; H04L 67/1023; H04L 67/1008; H04L 43/0876

(57) ABSTRACT

The method includes an IT model-based chargeback system with method of accounting for technology-related expenses that applies the cost of cloud services, hardware and software to the business units in which they are used. In this specific budget for each business unit is allotted by the organization as per their requirement. If the allocated expenditure of business unit crosses within month, warning message will send to that respective manager. This will be helpful for managers to monitor the resource consumption by business unit. Also, system provides available cloud resources reallocation for business unit whose consumption crosses the threshold value. At the month end admin will analyze all cloud bills & generate chargeback report for each team manager so that manager can take appropriate decision for efficient use of cloud resources.

### TECHNICAL FIELD

The present invention relates to field of cloud computing more particularly consumption, alert and resource reallocation above threshold to kind of chargeback on cloud resources.

### BACKGROUND

This discloser relates to model based chargeback system. Business units uses cloud resources. The consumption of cloud resources by business units are monitored by cloud brain's monitoring system. This is nothing but the predefined cross check of threshold value of cloud consumption resources. If cloud resources consumption crosses the threshold value, accordingly alert message will be sent to manager and respective managers will decide whether to continue with resources consumption or stop the consumption.

One more case we have shown if cost consumption crosses threshold value and i.e. allocated resources. Resources reallocation is very useful concept. When the cloud brain (CB) finds threshold, value has been crossed then CB can suggest available resource allocation option if available. By this teams who have more than needed resources will allocate their free/available resources to needy one.

If there is no resource reallocation available then directly manager will take decision about continue or stop resource consumption. After the month end, manager will receive the chargeback report from admin's assessment of total cloud bills. Based on chargeback report manager will be able to take appropriate decision on cloud resource consumption.

Chargeback is an accounting strategy that applies to the cost of IT hardware, software, cloud services or shared services to the business units in which they are used. A chargeback system is a method of accounting that allows a creative executive to charge the clients, organization or business teams for the cost associated with their projects.

This system contrasts with traditional IT accounting models in which a centralized department bears all the IT costs in an organization and those costs are treated simply as corporate overhead. Chargeback makes managers aware of the costs of IT and it is generally used to control escalating IT costs, to improve decision making, to align behavior with organizational goals and leads to more effective use of IT resources.

### SUMMARY OF THE INVENTION

The purpose of the present invention is to provide warnings to manager if his team uses cloud resources beyond the assigned threshold value and give option of available resources reallocation. By providing the resource reallocation business unit who has consumed more than threshold can continue their work with new allocated cloud resources due to which their work will not get stop. For this organization will not pay any extra amount to the cloud provider. This is the main advantages of this discloser.

At the month end billing cycle of system, admin analyze bills and generates team wise chargeback. This report helps manager to study his teams resource consumption. He can easily find difference between the allocated actual budget and practical used budget and can take appropriate decision to improve cloud resource handling effectively.

Implementing an acceptable and effective system of model-based chargeback for cloud services can have multiple benefits for a company. It makes business teams aware of the resources they are consuming (often resulting in a reduction of consumption) and encourages business managers to make better decisions about their resource requirements and priorities, improving the performance of the whole company.

We can make this model-based chargeback in cloud application system more effective and acceptable is through tagging. Use the user define tagging. Tagging enables companies to allocate cloud cost to business units in a transparent, understandable, accurate, and controllable manner. Depending on which cloud services provider is selected, companies can allocate tags per department, allowing for a degree of granularity that will satisfy any business manager's desire for measurability and accountability.

### BRIEF DESCRIPTION OF DRAWINGS

FIG. 1 is a flow diagram of model-based charge back in cloud application;

FIG. 2 is a block diagram of model-based charge back in cloud application;

FIG. 3 is a functional diagram of model-based charge back in cloud application;

FIG. 4 is the table of example of model-based chargeback in cloud application;

FIG. 5 is the table of example of resource reallocation table for model-based charge back in cloud application.

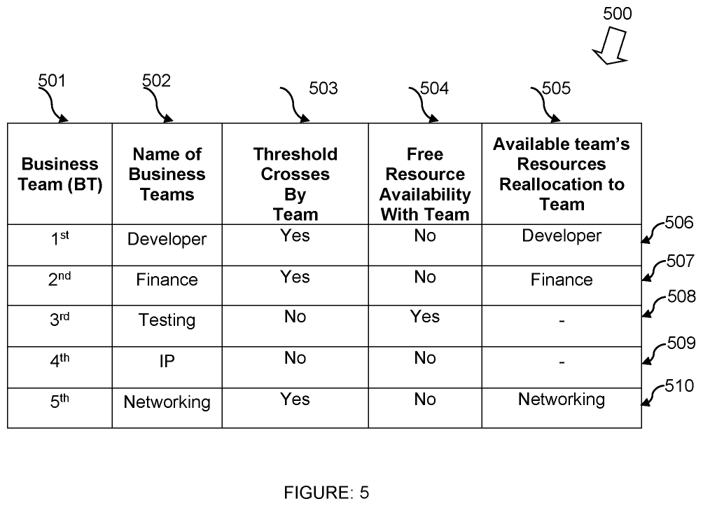

### DETAIL DESCRIPTION

The subject matter described here is related to the system which provides end users with more transparency into which business decisions are creating expenses and helps management to identify how to achieve greater profitability. The cost of legacy systems, redundancies or expensive proprietary technologies also become clear, providing IT staff with an effective rationale for upgrades that are intended to improve utilization or reduce energy use and administration time.

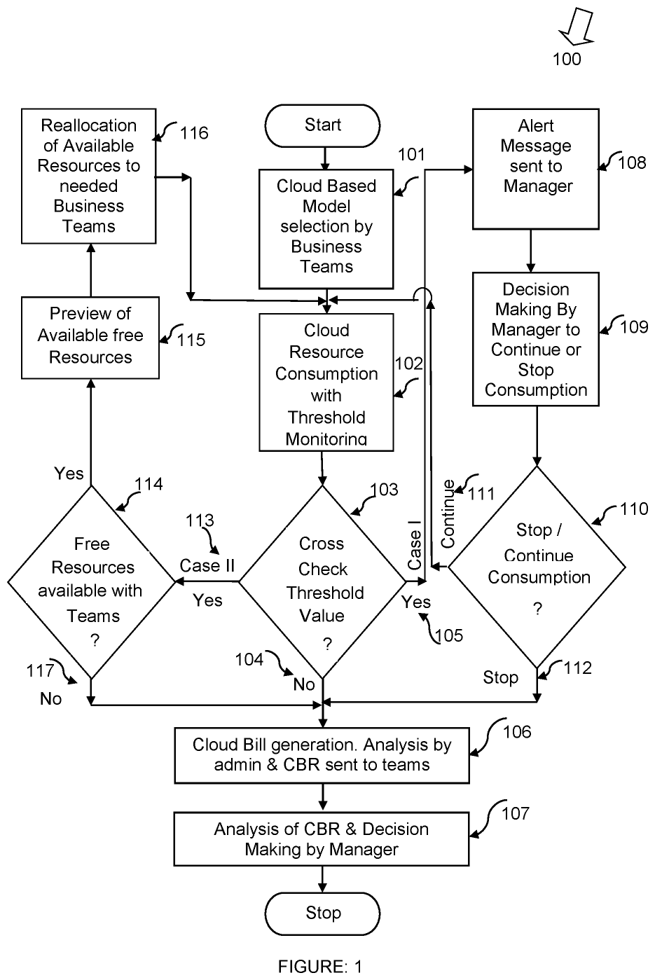

FIG. 1 is the flow chart of model-based chargeback in cloud application. In system 100, different cloud-based model will be selected by the teams 101 as per their required cloud services. Here one team can use multiple cloud services or single cloud services.

Selection of different cloud services by the team managers or organizational head is on the basis of cost of cloud services. N number of cost model will be available for teams. Team managers will select the cloud model based on cloud services 101. Team may use multiple cloud with multiple/single cloud services or single cloud with single/multiple service.

After selection of clouds for the services, teams will start consuming the cloud resources 102. During the process of consumption of cloud resources parallelly cloud brain will monitor the cost consumed by these resources 102. For each team their will, be the threshold value 103 for cost model.

If team cross threshold value 105 case I of cost model 103 in given time, then cloud brain will send warning/notification message to the managers 108. This message will give alert to managers that usage of cloud resources has increased up to or beyond threshold, and you need to take care of it. After receiving this message managers of team will make decision 109 to control the usage of cloud resources so that cost consumption can limit.

Managers will decide that should cloud resource consumption continued or not 110. If manager decide to stop consumption 112, then team will not able use any more resources and if manager will allow teams to consume 111 cloud resources then team will continue to use.

If team doesn't cross threshold value of the cost of consumption 104 of cloud resources in given time, then cloud brain will not send any warnings or notification to the managers. User will continue with use of cloud resources.

At the end of the monthly bill cycle, administrator of organization will receive all cloud bills 106, he will analyses all those cloud bills and will generate team wise chargeback reports 106. Managers of each team will analyses the chargeback report and as per report they will take decision 107.

Let's see the case II 113 if team crosses the threshold value, system will check for availability of resource for reallocation 114. If no resources are available, then admin will go for final billing 117. But if resource allocation is available then cloud brain will show preview of available resource 115. And finally, available resource reallocation 116 will take place. Team will continue to use reallocated resources 102.

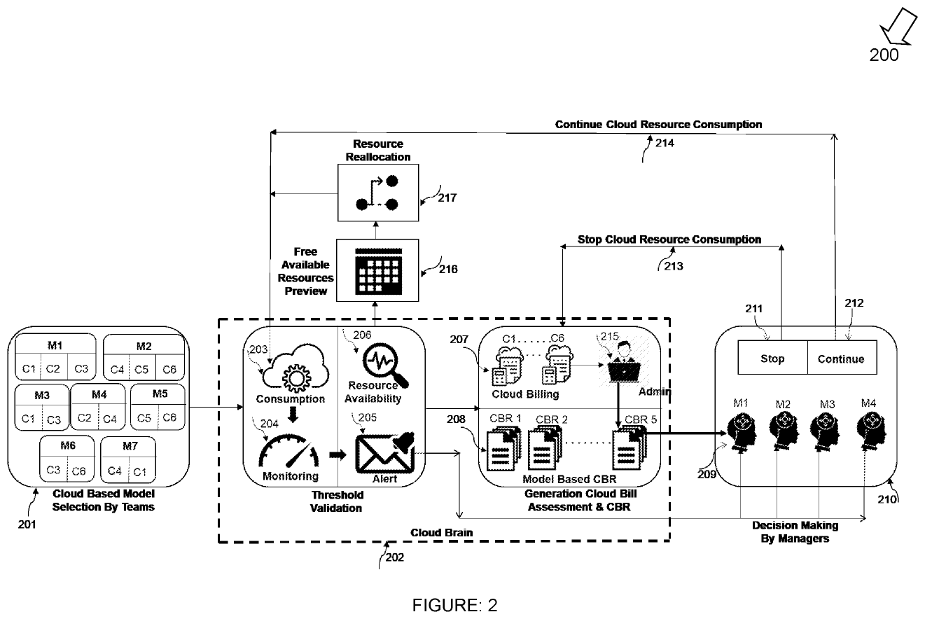

FIG. 2 is a block diagram of model-based charge back system for multi-cloud. In system 200 business teams selects cloud-based model 201. Different seven cost model of cloud has been shown here namely M1, M2, M3, M4, M5, M6 and M7 with different clouds' combination. Business team may use any of the cost model or combination of some model as per their allotted budget.

Business teams will start consuming cloud services 203. While consuming the cloud services cloud brain will keep monitoring 204 on the consumption of cloud resources.

The cloud resources and cost consumption will continuously get monitored 204 and if the cost for specific business team is crossed beyond the set threshold value in given time duration then warning or notification 205 will sent to the respective Managers 211. But if it does not cross the threshold value in given time duration then no warning/notification will be sent.

After receiving the warning messages the respective managers will check the consumption bills and will take the appropriate decision 211 that, should continue the team to use cloud resources. If he allows to use cloud resources 214, then team will continue with use of cloud resources 203 or if he will not allow 213 then no teams will be able to use cloud resources.

At the end of monthly bill cycle admin will receive monthly bill from all cloud providers 208, admin will analyze these cloud bills and generate team wise chargeback reports (CBR) 209 and distributes to all managers. Manager will analyze the CBR and take appropriate decision 211 to use cloud resources efficiently.

One more condition, in case consumption crosses threshold value then cloud may suggest option of resource reallocation for this system will check is resource available? 206. Cloud brain will check that is there any resources available? If resources are available, then cloud brain will show the preview of available resources those who needs resources 216 and finally cloud brain will reallocate the resources 217. If resource reallocation is not available, then admin will 215 take appropriate decision.

If consumption cost does not cross the threshold value 203 then team will continue to use cloud resources and at the end of the monthly bill will be generated 207.

Every organization receives the monthly bill 207. This cloud wise bill will be received by organization. Administrator will analyze all these cloud wise bills 207 and generates team wise chargeback report 208. This chargeback report will be distributed by the admin among the different team managers 210.

This team wise chargeback report will be consisting of multi-cloud with multiple cloud services 208. On the basis these chargeback report 208 managers of different team 210 will analyze the chargeback report and on the basis of CB report, manager will take appropriate decision 210 for proper utilization of cloud resources.

This Chargeback report makes things clear for manager who have to manage cost and can also help to provide a clear idea for various IT resource options. With so many types of clouds and SaaS services proliferating across the business world, IT chargeback model can be a useful way of ordering information and assessing value for cost.

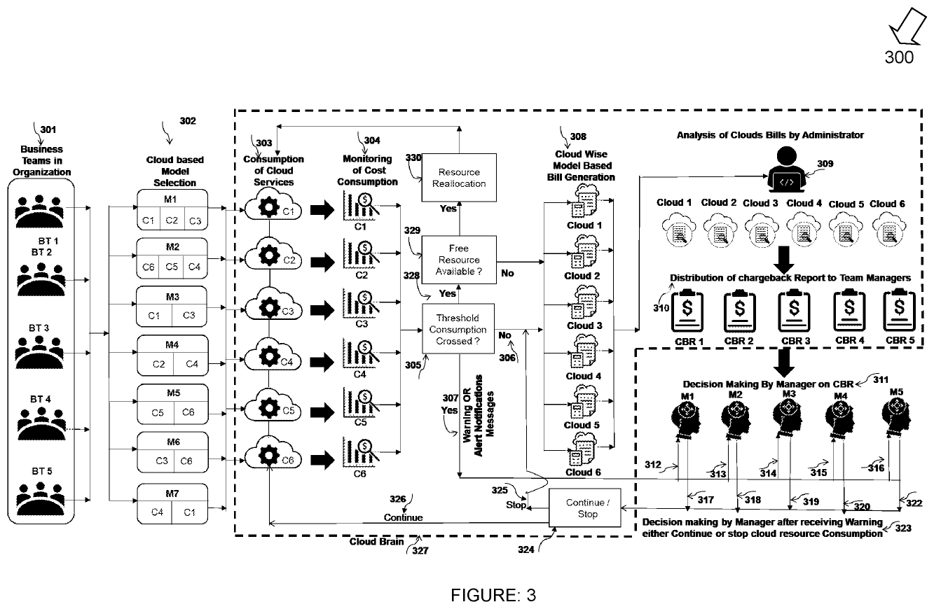

FIG. 3 shows the functional block diagram of model-based chargeback in cloud environment. In the system 300 different business units 301 has shown in proliferating. Five business teams 301 have shown here namely BT 1, BT 2, BT 3, BT 4, BT 5.

These business teams will select cost model with multiple cloud with single or multiple cloud resources. This selection of cloud resources is done on the basis of model of cost 302. In system 300 seven cost model 302 has shown, namely M1 to M7. Every cloud will provide theft cloud services on the basis of some model of cost.

Team will select the cost model 302 of multi-cloud and will start the consumption of cloud resources 303. The cloud resource consumption will be monitored 304 for each cloud model.

If the consumption cost of cloud resource for any specific team or for all teams is crossed beyond the threshold value 305, then cloud brain will send warning message 307 to respective team managers 312, 313, 314, 315 and 316. Then managers will decide and take appropriate decision 311 about increasing cost of cloud resources consumption. Manager may continue or stop 324 the cloud resource consumption. Either he will Continue 326 with consumption of cloud resource or he stops 325 to cloud resource consumption 317, 318, 319, 320 and 322.

In other case if cloud resource consumption crosses the threshold value 328 then cloud brain can search that is free resource available with other teams? 329. If free resources are available, then cloud brain will show the available resource preview and cloud brain will reallocate 330 possible cloud resources from other teams and reallocate those free available resources to them then consumption starts.

If manager intimate to stop cloud resource consumption 325 then at the end of monthly bill cycle, regular cloud bill 308 will be sent to organizational administrator 309. Consolidated bills will be analyzed by administrator 309 to generate team wise charge back reports 310. After generation of team wise charge back report admin distribute these CB reports among the managers 311.

Here in these 300 systems, as there are five teams so five chargeback reports have been generated 310 namely CBR 1 to CBR 5. Team managers 311 namely M1 to M5 will study this chargeback report carefully and take appropriate decision for efficient use of cloud resources by team members.

But if consumption cost does not cross the threshold value then warning/notification 308 will not be sent. Direct cloud wise bill be sent 308 to the administrator of an organization 309. Administrator of an organization will analyze the consolidated regular bill reports of all clouds 1 to cloud 6. After analysis of this consolidated cloud wise bill, he will generate chargeback reports 310 for each team i.e. CBR 1, CBR 2, CBR 3, CBR 4, CBR 5.

All these chargeback report will be sent to theft team managers. Team managers 311 will study this chargeback report carefully and take appropriate decision for appropriate use of cloud resources by team members.

One more case we have to consider if cloud resources consumption crosses the threshold value 328 then cloud brain can search that, is free resources available or not? 329. If free resources are available then cloud brain will show the free available reassures for reallocation in matrix and cloud brain reallocates possible cloud resources from other cloud model and continue with cloud resources consumption.

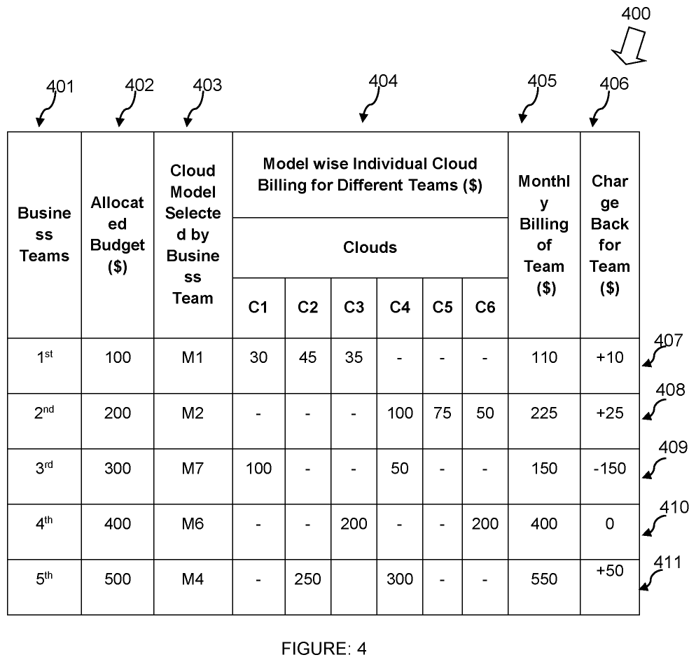

In FIG. 4 table explains the example of model-based charge back. This table mainly consists of business team 401, allocated budget ($) 402, cloud models selected by business teams 403, model wise individual cloud billing for different teams (in $) 404, monthly billing of teams ($) 405 and chargeback amount on each team ($) 406.

Consider the example 407, for 1^{st} business team 401 total cloud resources allocated budget is 402 $100, business team 1 has selected M1 cloud model 403. This model consists of three different cloud C1, C2, C3, so team will use different services of these three clouds.

From cloud 1 actual consumed cost is $30, cloud 2 is $45 and cloud 3 is $35 and total consumed cost by teams is $110. So, from this give information we can find chargeback amount on 1^{st} business team. In this case chargeback for 1^{st} business team is +$10. Plus sign indicates that team has expended more than the allotted budget.

In the column 406 shows that negative values 409 indicates that cost consumed by teams is within the limit and positive value 407, 408, 411 indicates that teams has crossed the allotted budget. In the record of 410 charge back for team 4 is zero. As allocated budget 402 is equal to the monthly bill 405.

System 500 shows the table of available resources and reallocation to required team. Five different business teams 501 namely developer, finance, testing, IP, networking 502. 503 shows which teams crosses threshold by teams, 504 shows that free resource is available or not. 505 is the available teams' resources reallocation to team. 1^{st} team is developer and for this team new resources have been allocated 505. Testing teams' resource allocated 505 to developer team. From table 4 we can see 409 3^{rd} team's resources we can use. They have enough resource. That's why admin will decide that whose resource will be shared among the teams.

Table 500 indicates the total available teams and new allocated resource to team who is having deficiency of resources. 506, 507, 510 are the three teams who were having resources deficiency and testing team 504 is having enough resource. So, testing teams' resource will get shared with among the teams. Testing 508 and IP 509 team don't need any resource reallocation as they are having their own resources.

In model base chargeback system, teams select clouds and their services on the basis of some cost model. Cost model includes cloud services of different cloud with cost. Single team may use multiple cloud services of multi-cloud. Chargeback reports include this bifurcation of different cloud and multiple cloud resource consumption.

It helps the team managers to keep watch on cloud resource consumption. If the consumption of cloud resources is above the defined limit value, managers will get informed by warning massage so that they would take appropriate decision. And free available resource cloud brain will suggest this option to work continually. Business teams may select resource reallocation for efficient use of available resources of other teams. This will balance an economical uneven load of organization.

What is claimed is:

1. A model-based chargeback in cloud applications system comprising:
at least one business unit;
a cloud based-model;
a cloud brain, wherein the cloud brain is configured to:
monitor cloud resource consumption;
perform at least one of:
send warnings message to the manager of the at least one business unit based on the cloud resource consumption cross threshold value;
send bill based on the cloud resource consumption do not cross the threshold value;
reallocate a resource; and
generate chargeback report; and
a manager of the at least one business unit, wherein the manager is configured to:
take decision to limit the cloud resource consumption based on the received warnings message; and
take decision making by manager based on the received warnings message and the generated chargeback report.

2. The model-based chargeback in cloud applications system of claim 1, wherein the at least one business unit can consist of at least one business teams and at least one cloud provider with different cloud-based model.

3. The model-based chargeback in cloud applications system of claim 1, wherein the manager will select the cloud-based model based on allocated budget.

4. The model-based chargeback in cloud applications system of claim 2, wherein the at least one business team uses cloud resources of assigned clouds in the cloud-based models, and wherein the threshold value is allotted to the at least one business team.

5. The model-based chargeback in cloud applications system of claim 1, wherein the cloud resource consumption is monitored by the cloud brain.

6. (canceled)

7. The model-based chargeback in cloud applications system of claim 1, wherein the cloud brain based on the cloud resource consumption cross the threshold value is configured to:
notify free resources of other business team; and
reallocate the free resources to the at least one business team.

8. The model-based chargeback in cloud applications system of claim 1, wherein the chargeback report consists of allocated amount to the at least one business unit and actual consumed amount, wherein the manager is further configured to calculate extra amount spent by the at least one business unit.

9. The model-based chargeback in cloud applications system of claim 1, wherein the manager is configured to take decision about the at least one business team regarding the efficient usage of cloud services based on the generated chargeback report.

10. This model-based chargeback in cloud applications system of claim 1, wherein the cloud based-model can provide more accountability and controllability on IT assets and services as well as timeliness and congruence with general goals of the at least one business unit.

11. The model-based chargeback in cloud applications system of claim 1, wherein the cloud brain is configured to reallocate the free resource based on the cloud resource consumption cross threshold value.

12. (canceled)
